(19) United States
(12) Patent Application Publication
(10) Pub. No.: US 2015/0201327 A1
(43) Pub. Date: Jul. 16, 2015

(54) TRAK-OFF CELL PHONE CASE TO PREVENT CELL PHONE TRACKING BY GPS, CELL TOWER, SATELLITE, WIRELESS NETWORK, ACCESS POINT, OR OTHER WIRELESS MEANS

(71) Applicant: Wiiliam Arthur McMahon, Hemet, CA (US)

(72) Inventor: Wiiliam Arthur McMahon, Hemet, CA (US)

(21) Appl. No.: 14/152,919

(22) Filed: Jan. 10, 2014

(51) Int. Cl. H04W 12/02; H04M 1/04; H04B 1/38; H05K 9/00

(52) U.S. Cl. CPC H04W 12/02; H05K 9/0007; H04M 1/04; H04B 1/3888

(57) ABSTRACT

A cell phone case utilizing an embedded layer to prevent electromagnetic waves (cell phone signals) from passing through. When a cell phone is inserted and the case closed it prevents all communication to and from the phone. This prevents the phone from being tracked and allows the users to effective shut down the functionality of the phone while leaving it electrically on. This offers privacy to the user while saving the time of powering down and powering up the phone.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Trak-Off cell phone case is a product for the millions of cell phone users across the world who object to cell phone tracking whether by businesses, municipalities, governments or individuals. The product best fits into U.S. patent classification 379 (Telephonic Communication) though it is designed not to enhance, but to prevent unwanted cell phone communication. As cell phone technology has increased in recent years so has the amount of data and personal information they share and the desire by users to have more control over when and where that information is shared. Concurrent with increases in cell phone technology have been increases in the development of other technology to track (through global positioning systems), to intercept metadata, or to use the wireless connectivity capabilities of cell phones to gather information about users, their location, habits and activities. A check of news articles will reveal that everyone from international governments to national security agencies to local police departments to corporations are either gathering or planning to gather cell phone information either as anonymous metadata or as user specific information. Though these problems are not problems for the cell phone industry or technological problems they are very real problems for the end users of these products.

Some of these problems can be solved by turning off the cell phone but as phones have become more complex (“smart phones” for example) the time necessary to shut down and restart a phone has increased to the point that it is seldom an option for end users simply looking to avoid being tracked or to avoid unwanted calls, texts or emails. Phones too, like the computers they are becoming, have varying stages of “off” from completely powered down to sleep mode to simply the screen being off. It is not always easy for the end user to know what state the device is in at any particular time.

As a science teacher I avidly follow news and technology developments. (I possess a California teaching credential as well as a B.A. degree in biology, and an M.A. in environmental science education and have taught mathematics, algebra, biology, physics, astronomy, chemistry, geology, electricity and magnetism for nearly 25 years.) Drawing on my knowledge of electromagnetic waves (of which cell phone communications are part) and the famous Benjamin Franklin and Michael Faraday experiments (1755 and 1836 respectively) that demonstrated that electric charges travel only on the outside surface of metal mesh I began to design a solution to these problems that would be portable, attractive, simple and ultimately return control of information to the cell phone users themselves. Eventually after much design, experimentation, sewing, gluing, building, testing, analysis and redesign the Trak-Off case in its current form was developed.

### BRIEF SUMMARY OF THE INVENTION

The general idea of the Trak-Off cell phone case is to block all communication to and from the cell phone. It allows the user to quickly insert the phone and, by securing the velcro tab, block all communication to and from the phone. This not only prevents tracking, but also blocks emails, texts and calls just as if the phone was off. For the user a key part of the design is convenience. Don't want to be bothered in a business meeting, at the movies, or while at lunch? In less than two seconds the phone can be secured in the Trak-Off case and the user has instant privacy. This is far faster than powering down the phone and can be reversed just as quickly.

Specifically the Trak-Off case solves the problems mentioned in the previous section: problems of cell phone tracking for the end-user (whether by businesses, governments or individuals) and problems of privacy without having to actually shut down the phone. The Trak-Off case is also a phone case and provides the basic protection to the phone and screen that any such case provides.

### BRIEF DESCRIPTION OF THE SEVERAL VIEWS OF THE DRAWING

FIG. 1 shows a template for the shell of Trak-Off phone case. Shell to be cut from cloth, fabric, leather, vinyl or other suitably flexible and durable material. Two working prototypes have been built. The first uses heavy sofa fabric. The second uses synthetic leather (vinyl) with a bonded fabric backing.

FIG. 2 shows template for the metal foil layer of Trak-Off phone case. This layer is the same size and shape as the shell and when joined together is what gives the case its functionality. Testing has shown that the thickness must be 0.001 inch (0.03 mm) or greater to be effective. It has been tested up to 0.002 inch (0.06 mm) in thickness, but that begins to interfere with the ease of closing the Trak-Off case.

FIG. 3 shows a template for the liner of Trak-Off phone case. Liner to be cut from microfiber fabric or other suitably soft, thin and light material. The liner prevents the metal foil from directly contacting the cell phone. The liner is smaller than the foil and shell layers. This allows the metal layer to maintain electrical continuity when the case is completed.

FIG. 4 shows the three layers laminated together with adhesive (from top down: liner, metal foil, fabric shell.). The phone case closure tab is also shown. The case is then folded in half as shown joining the exposed metal foil. Case is then sewn along the edge stitching the exposed foil together.

FIG. 5 shows the completely assembled Trak-Off phone case. The case is open at the top. When the phone is inserted and the top is folded over and secured with the velcro tab it becomes fully functional. The closed case blocks all incoming and outgoing cell phone signals causing the phone to behave as though it has been turned off preventing communication with (and tracking by) GPS, cell tower, wireless networks or access points.

FIG. 6 shows a front view of the Trak-Off phone case in the closed position.

FIG. 7 shows a back view of the Trak-Off phone case in the closed position.

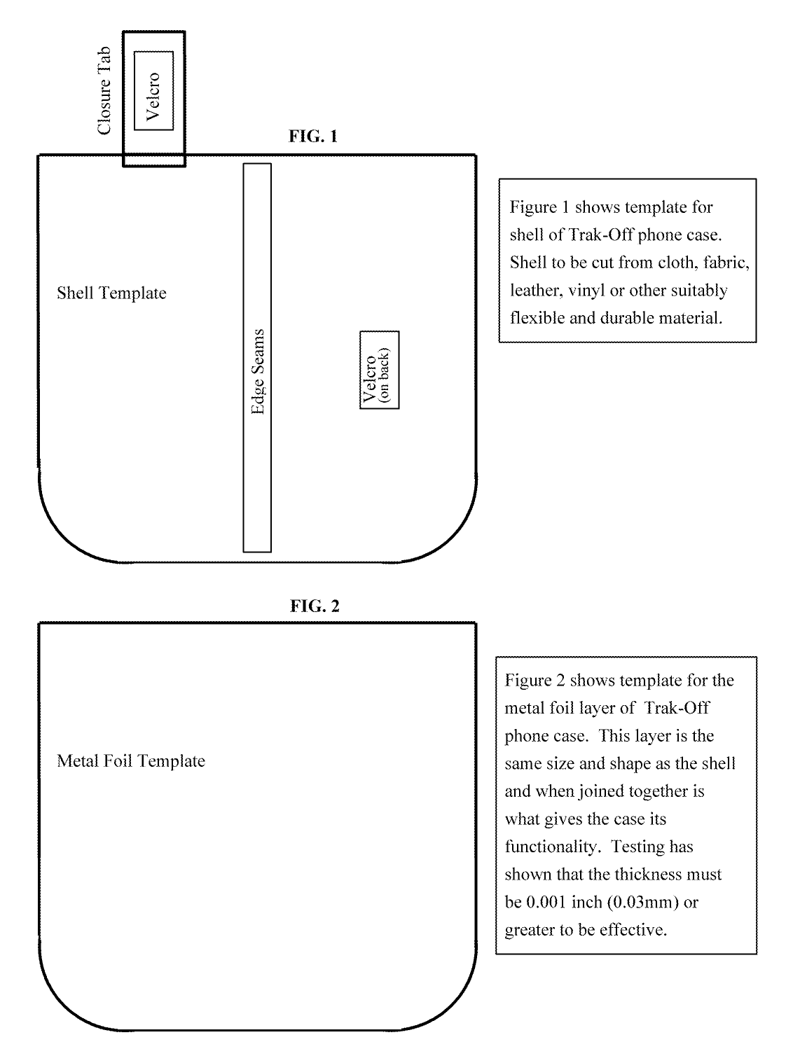

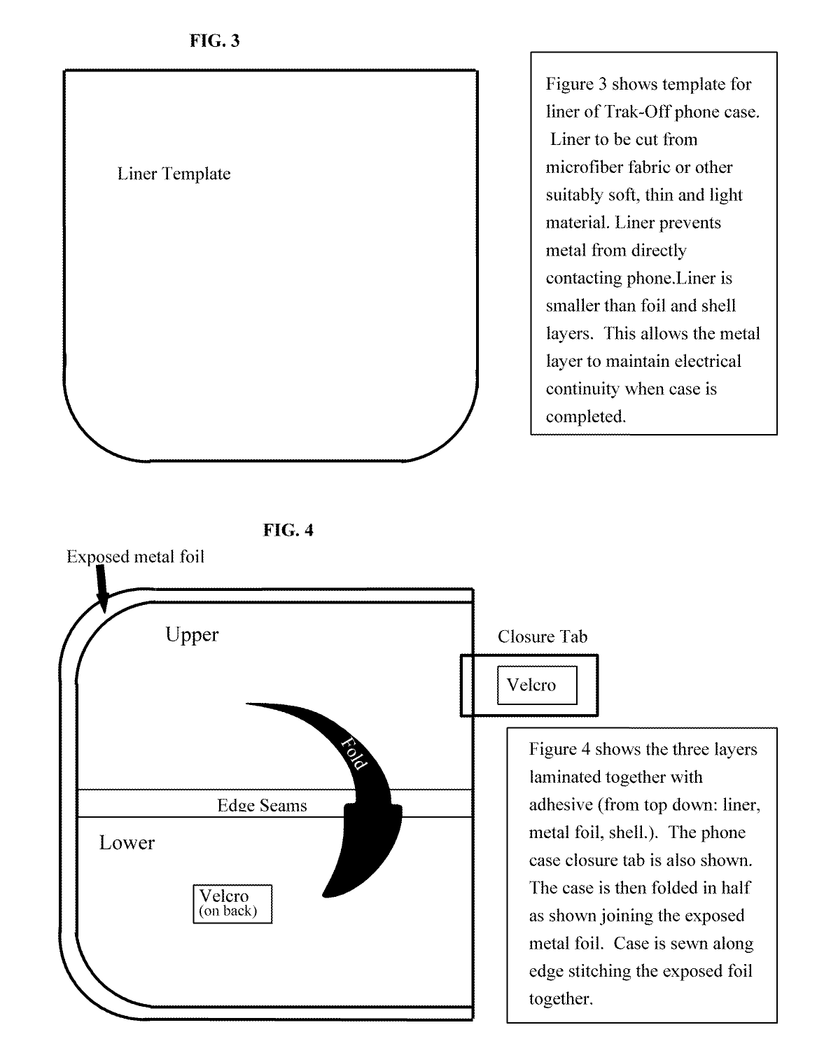

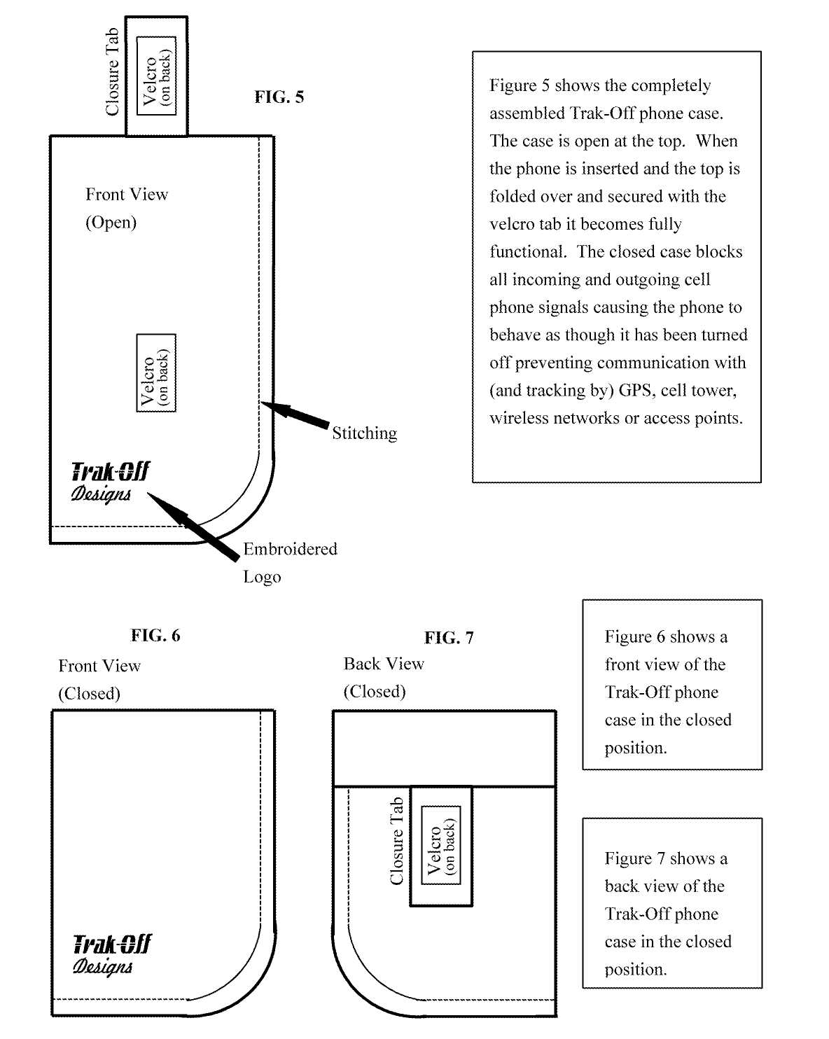

### DETAILED DESCRIPTION OF THE INVENTION

The Trak-Off cell phone case is soft sided fabric or leather case, closed on three sides, but open at the top for the insertion and removal of the user's cell phone. Closure of the top is achieved by use of an extended flap that is folded over and secured with a velcro closure system. The key design feature of the case is the embedded foil layer (imperceptible to the user) that blocks all incoming and outgoing cell phone signals when the case is closed.

For the two functioning prototypes developed the following procedure was used to produce them:

1. Mark and cut shell.

2. Mark and cut closure tab.

3. Mark and sew velcro tab to shell.

4. Sew “Trak-Off Designs” logo to shell.

5. Apply spray glue to closure tab, fold half in on both sides.

6. Mark and sew velcro to closure tab.

7. Apply spray glue to shell, adhere foil.

8. Mark and cut liner material.

9. Apply spray glue to liner and adhere to foil.

10. Cut seam tape to length for top edge.

11. Cut slot for closure tab.

12. Sew seam tape and closure tab to top edge.

13. Sew tab slot closed.

14. Sew seam tape to end of closure tab.

15. Fold assembled shell in half and sew together with seam tape in place.

16. Sew ends of seam tape.

17. Test!

It is my intention to have the Trak-Off cases mass produced. This may entail automating many of the steps involved in making the prototypes or even replacing them altogether with better techniques. For instance it may be more cost effective to heat bond rather than sew the edges or perhaps to secure with some type of bonding crimp. There are doubtless many techniques that I am unaware of that may be suggested either to reduce cost or to improve durability or improve manufacturability. Regardless of design or manufacturing changes the basic premise of the Trak-Off case will remain: a portable, attractive, simple, cell phone case with an embedded metal foil layer for blocking all communication to and from the cell phone. There is no other cell phone case on the market with such a functionality.

The embodiments of the invention in which an exclusive property or privilege is claimed are defined as follows:

1. A cell phone case comprised of one or more layered materials at least one layer of which is utilized to prevent electromagnetic cell phone signals from reaching the cell phone and to prevent electromagnetic cell phone signals produced by the cell phone from leaving the case thus rendering the functionality of the phone the same as if it was turned fully off and rendering non-functional any ability to track the phone, read metadata, intercept phone communication, send or intercept email, send or intercept text, send or intercept calls, or send or intercept wireless signals of any kind (rendering it the same as if the phone was fully off.)

2. The said cell phone case recited in claim 1 wherein said case is comprised of a decorative layer (the shell), a soft inner layer (the liner) and an embedded signal shielding layer between the other two and of which the case is permanently enclosed on one to three sides (edges) as well as the top and bottom of the case by a soft or hardened fabric, plastic, vinyl, leather, metal or other suitable material shell, an embedded metal layer (either foil, mesh, or solid), and a liner where the user can place the cell phone and close the case so that the cell phone is closed in on all sides and no electromagnetic cell phone signals can pass through the case.

3. The said cell phone case recited in claim 1 wherein said case when assembled maintains electrical conductivity along one to three sides of the assembled case as well as the top and bottom of the case, and when used by the cell phone user maintains electrical conductivity along four sides of the case as well as the top and bottom of the case, completely surrounding the cell phone inside the case with a signal shielding layer.

4. The said cell phone case recited in claim 1 wherein said case has an opening at the top that is secured by the user and made functional by the user by folding over and securing the case closed with velcro or other suitable closure material and when closed is fully functional in blocking electromagnetic cell phone signals even when the cell phone is on and case is considered “functional” or to be “functioning” when all incoming and outgoing electromagnetic waves are blocked.
